(19) United States
(12) Patent Application Publication
(10) Pub. No.: US 2014/0325794 A1
(43) Pub. Date: Nov. 6, 2014

(54) MICROPHONE HOLDER

(71) Applicant: David Merton, Bedford, TX (US)

(72) Inventor: David Merton, Bedford, TX (US)

(21) Appl. No.: 14/267,907

(22) Filed: May 1, 2014

Related U.S. Application Data
(60) Provisional application No. 61/818,105, filed on May 1, 2013.

(51) Int. Cl. H04R 1/02

(52) U.S. Cl. CPC H04R 1/02
USPC 24/3.12

(57) ABSTRACT

A microphone holder is configured to enable a user to clip a microphone to a shirt. The microphone holder has a plate that is punched with a hole and bent into a J-shape. The hole is configured to accommodate a microphone. The plate is configured to be adapted to a shirt.

### RELATED APPLICATION

This application claims priority to provisional patent application U.S. Ser. No. 61/818,105 filed on May 1, 2013, the entire contents of which is herein incorporated by reference.

### BACKGROUND

The embodiments herein relate generally to clothing accessories.

Prior to the disclosed invention, microphones were mounted to a police officer's epaulet or front of shirt. As a result, some officers could not be heard well because they kept the microphone on one's shoulder. Further, officers had to turn their head to talk toward the microphone, which took one's eyes off of one's focal point, which could be dangerous. If an officer could not use one's hands, for instance when using both hands with a suspect or if injured, the officer could not activate the microphone. Additionally, the shoulder mounted microphone came with a cord of sufficient length to choke the officer if the cord was engaged by a suspect. If injured in a fight or strenuous activity, the microphone would become detached and was useless. The present invention solves these problems.

### SUMMARY

A microphone holder is configured to enable a user to clip a microphone to a shirt. The microphone holder has a plate that is punched with a hole and bent into a J-shape. The hole is configured to accommodate a microphone. The plate is configured to be adapted to a shirt.

### BRIEF DESCRIPTION OF THE FIGURES

The detailed description of some embodiments of the invention is made below with reference to the accompanying figures, wherein like numerals represent corresponding parts of the figures.

FIG. 1 shows a schematic perspective view of one embodiment of the present invention;

### DETAILED DESCRIPTION OF CERTAIN EMBODIMENTS

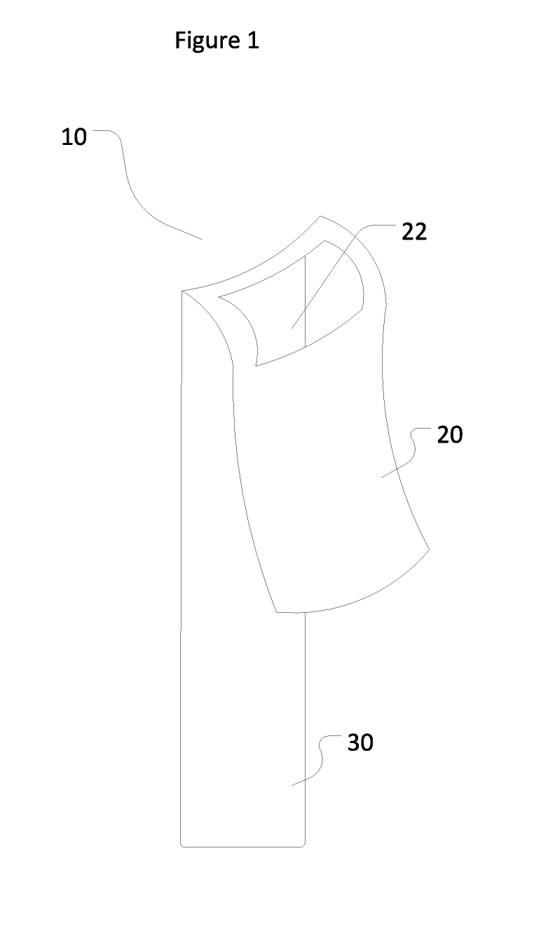

By way of example, and referring to FIG. 1, one embodiment of the present system 10 comprises plate 20 that is punched with hole 22 and bent into a J-shape causing body 30. The J-shape is smoothed of rough edges, covered with a rubberized coating and allowed to dry. The J-shape is mechanically coupled to a hook and loop fastener which can be further mechanically coupled to a uniform item. The J-shape can be worn on in the middle of a police officer's shirt as the J-shape is secured to the concealable and outer vest carriers. The microphone can be clipped to the hole so that the officer does not have to turn one's head to use the microphone and will not detach from the improved microphone holder.

Turning to these components in more detail, the plate can be a seven inch by one inch piece of metal of other material that is punched with a ½ inch by ⅞ inch hole using a precision metal punch. The hook and loop fastener can be five inches long.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A microphone holder, configured to enable a user to clip a microphone to a shirt; the microphone holder comprising:
a plate that is punched with a hole and bent into a J-shape;
wherein the hole is configured to accommodate a microphone;
wherein the plate is configured to be adapted to a shirt.
